(19) United States
(12) Patent Application Publication
(10) Pub. No.: US 2014/0367378 A1
(43) Pub. Date: Dec. 18, 2014

(54) Trapezoidal, Flanged Out, Slanted Transformer Tank With Glued Shoe Box Cover

(71) Applicant: ABB Technology AG, Zurich (CH)

(72) Inventors: Bryan Zweifel, Linn, MO (US); Dana L. Basel, Jefferson City, MO (US); Joe W. Neuenswander, Jefferson City, MO (US); John V. Jacobson, Jefferson City, MO (US); Robert I. Sumner, California, MO (US)

(21) Appl. No.: 13/917,674

(22) Filed: Jun. 14, 2013

(51) Int. Cl. H01F 27/02; B29D 99/00; B65D 43/14; B29C 65/48; B65D 85/00; H01F 41/00

(52) U.S. Cl. CPC H01F 27/02; B65D 85/00; B65D 85/70; H01F 41/00; B65D 43/14; B29C 65/48; B29D 99/0096; B29L 2031/565
USPC 220/4.12; 29/606; 29/428; 156/69

(57) ABSTRACT

A tank for a transformer includes a left side wall, a right side wall opposing the left side wall, a front wall, a rear wall opposing the front wall, and a trapezoidal-shaped base. Each of the left side wall, the right side wall, the front wall and the rear wall extends from the base so as to define a trapezoidal-shaped tank having an open end in communication with an interior space. The right and left side walls, and the rear wall are constructed and arranged so that the open end slants downwardly from front to back of the tank. A cover is adhered to the tank to cover the open end. The tank is constructed and arranged to house transformer components in the interior space.

### FIELD

The invention relates to single phase, pad mounted distribution transformer tanks and, more particularly, to a trapezoidal transformer tank with a cover adhered thereto.

### BACKGROUND

With reference to FIGS. 1-3, a conventional single phase, pad-mounted distribution transformer includes a rectangular tank 10 (some corners can be rounded) with a cover 12 coupled to the top of the tank 10. The cover 12 is typically domed (made slightly convex) to shed water. The domed tank cover 12 is coupled by a weld 14 to tank flanges 16 that protrude into the tank 10. These tanks 10 are typically difficult to manufacture due to the need of sophisticated bending presses used in forming the tank. Also, these tanks 10 require additional manufacturing steps such as grinding and painting the weld area.

Thus, there is a need to provide a trapezoidal-shaped transformer tank that eliminates wasted space and reduces the amount of oil needed and that has a cover, adhered to the tank, which eliminates the need for the welded, domed cover.

### SUMMARY

An object of the invention is to fulfill the need referred to above. In accordance with the principles of the present invention, this objective is obtained by a tank for a transformer. The tank includes a left side wall, a right side wall opposing the left side wall, a front wall, a rear wall opposing the front wall, and a trapezoidal-shaped base. Each of the left side wall, the right side wall, the front wall and the rear wall extends from the base so as to define a trapezoidal-shaped tank having an open end in communication with an interior space. The right and left side walls and the rear wall are constructed and arranged so that the open end slants downwardly from front to back of the tank. A cover is adhered to the tank to cover the open end. The tank is constructed and arranged to house transformer components in the interior space.

In accordance with another aspect of the disclosed embodiment, a method of providing a tank for a transformer includes arranging a left side wall, a right side wall opposing the left side wall, a front wall, a rear wall opposing the front wall, with a trapezoidal-shaped bottom wall so that each wall extends from the base to define a trapezoidal-shaped tank having an open end in communication with an interior space. The side walls and the rear wall are provided so that the open end slants downwardly from front to back of the tank. The method glues the cover to the tank to cover the open end.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a top view of a conventional transformer tank having a welded, domed cover.

FIG. 2 is a side view of the conventional tank of FIG. 1.

FIG. 3 is a front view of the conventional tank of FIG. 1.

FIG. 4 is a side view of a trapezoidal-shaped tank for a single phase, pad mounted distribution transformer in accordance with an embodiment of the invention.

FIG. 5 is top view of the trapezoidal-shaped tank of FIG. 4.

FIG. 6 Is a perspective view of the tank of FIG. 4, shown with the cover removed and without cable compartment connections.

### DETAILED DESCRIPTION OF AN EXEMPLARY EMBODIMENT

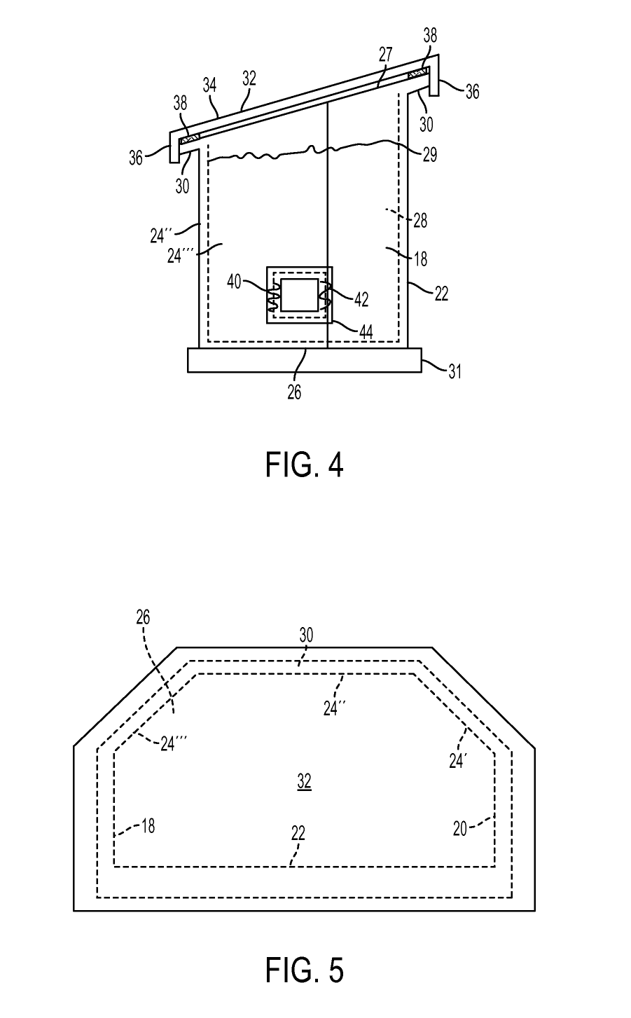

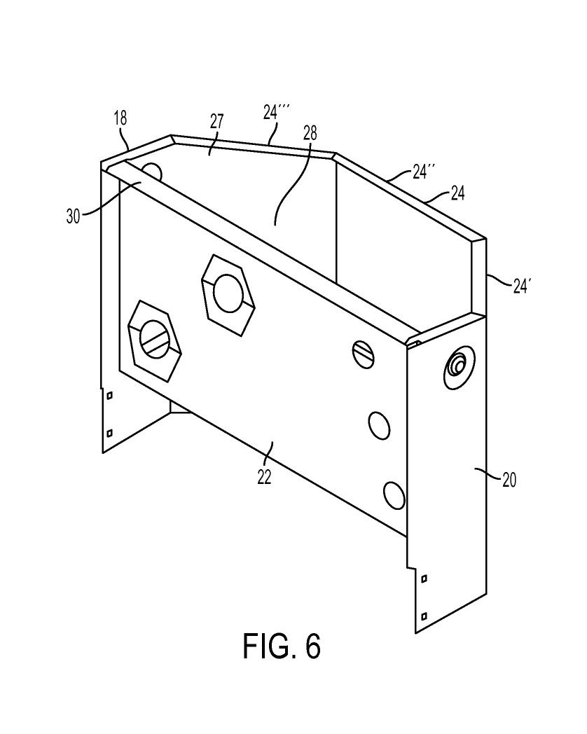

With reference to FIGS. 4-6, a tank for a single phase, pad mounted distribution transformer is shown, generally indicated at 10, in accordance with an embodiment. The tank 10′ has a left side wall 18, an opposing right side wall 20, a front wall 22, and an opposing rear wall 24. In the embodiment, the rear wall 24 includes three panels 24′, 24″ and 24″. Each wall 18, 20, 22 and 24 extends from a generally trapezoidal-shaped base 26 so as to define the trapezoidal-shaped tank 10′ having an open end 27 communicating with an interior space 28 (FIG. 6). The space 28 is typically filled with oil 29. The walls can be welded to the base 26 or some of the walls can be made integral with each other or with the base 26 and then bent and welded to the proper shape. The base 26 rests on a pad 31 that is sufficient to support the weight of the tank 10′. The front wall 22 is constructed and arranged to be adjacent to a cable compartment (not shown) of the transformer in the conventional manner.

As shown in FIG. 4, the side walls 18, 20 and the rear wall 24 are constructed and arranged so that the open end 27 tapers or slants downwardly from front to back of the tank 10′ to keep rainwater away from the front wall 22 of the tank 10′ and thus the cable compartment. Thus, the rear panel 24″ is shorter in height than the front wall 22. The trapezoid shape of the tank 10′ eliminates wasted space and reduces the amount of oil needed as compared to the rectangular tank of FIG. 1.

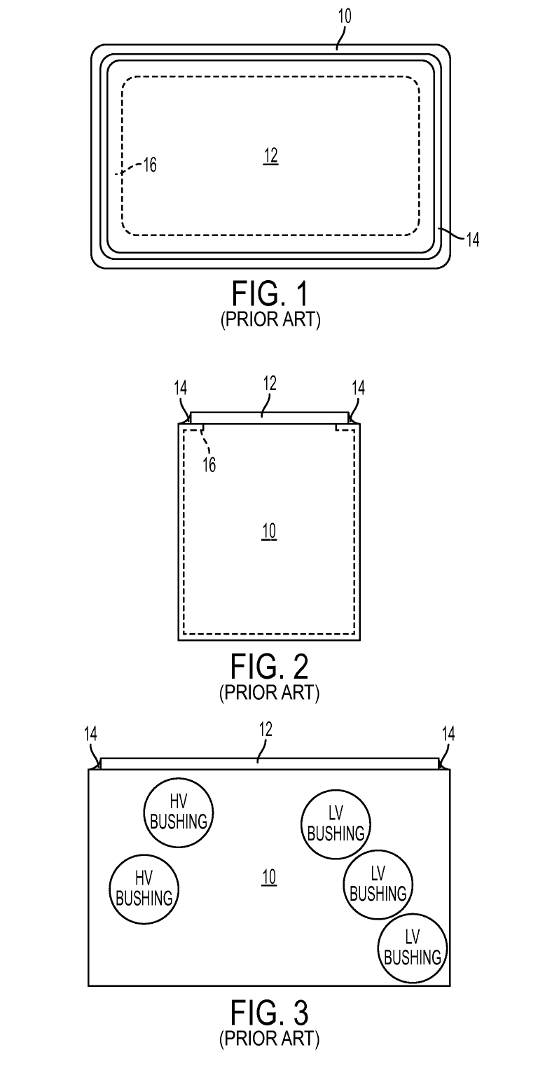

As best shown in FIG. 4, a tank flange 30 extends outwardly from each of the walls 18, 20, 22 and 24 at the periphery of the open end 27 of the tank 10′. Since the tank flange 30 extends outwardly from the tank 10′, it does not protrude into the interior space 27. A cover 32 covers the open end 28 of the tank 10′. The cover 32 has a trapezoidal-shaped top 34 and a cover flange 36 extending downwardly from the top 34 so that the cover flange 36 extends over the tank flange 30 to define a shoe-box like cover for the tank 10′. Glue or other adhesive 38 is provided about the flange 30 to secure the cover 32 to the tank 10′. In the embodiment, the glue 38 is preferably Loctite® 20003, a heat curable epoxy. Other adhesives can be used. The slanted shoe-box type cover 32 eliminates the need to dome the cover as in the conventional tank 10 of FIGS. 1-3. The cover 32 glued to the tank flange 30 eliminates the need to weld the cover 32 onto the tank 10′, and eliminates the steps following welding, namely, grinding the weld smooth, priming and painting the weld area.

Since the tank 10′ is preferably a tank for a single phase transformer, the tank 10′ includes a primary winding 40 and a secondary winding 42 on a laminated steel core 44 in the oil-filled interior space 28. The tank 10′ with outward extending flange 30 provides more room for windings and core, while allowing the tank 10′ to have a smaller volume as compared to the tank 10 of FIG. 1, again, reducing the amount of oil needed.

While the tank 10′ is somewhat smaller and less expensive than the conventional tank 10, a primary advantage of the tank 10′ is that it is easier to manufacture. The tank 10′ eliminates the problematic painting of the conventional cover weld area. Further, the tank 10′ does not require the use of a wing bender and can be bent on less sophisticated presses. Doming the cover 32 is no longer needed due to slanting of the cover 32. The cover 32 will use only simple 90° bends to form the cover flange 36.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A tank for a transformer comprising:
a left side wall,
a right side wall opposing the left side wall,
a front wall,
a rear wall opposing the front wall,
a trapezoidal-shaped base, the left side wall, the right side wall, the front wall and the rear wall each being coupled to and extending from the base so as to define a trapezoidal-shaped tank having an open end in communication with an interior space,
the right and left side walls and the rear wall being constructed and arranged so that the open end slants downwardly from front to back of the tank, and
a cover adhered to the tank to cover the open end,
wherein the tank is constructed and arranged to house transformer components in the interior space.

2. The tank of claim 1, wherein the tank includes a tank flange extending outwardly from the left side wall, the right side wall, the front wall and the rear wall at a periphery of the open end.

3. The tank of claim 2, further including glue, gluing the cover to the tank flange.

4. The tank of claim 3, wherein the cover includes a top and a cover flange extending downwardly from the top so that the cover flange extends over the tank flange to define a shoe-box like cover for the tank.

5. The tank of claim 1, wherein the top of the cover is of trapezoidal shape.

6. The tank of claim 1, in combination with a primary and a secondary winding on a laminated core as the transformer components in the interior space.

7. The tank of claim 1, further comprising oil in the interior space.

8. The tank of claim 1, wherein the tank is constructed and arranged for a single phase, pad mounted distribution transformer.

9. The tank of claim 1, wherein the rear wall includes a plurality of panels.

10. A method of providing a tank for a transformer, the method comprising the steps of:
arranging a left side wall, a right side wall opposing the left side wall, a front wall, a rear wall opposing the front wall with a trapezoidal-shaped bottom wall so that each wall extends from the base to define a trapezoidal-shaped tank having an open end in communication with an interior space,
providing the side walls and the rear wall so that the open end slants downwardly from front to back of the tank,
providing transformer components in the interior space, and
gluing a cover to the tank to cover the open end.

11. The method of claim 10, wherein the tank includes a tank flange extending outwardly from the left side wall, the right side wall, the front wall and the rear wall at a periphery of the open end, and wherein the gluing step includes gluing the cover to the tank flange.

12. The method of claim 11, wherein the cover includes top and a cover flange extending downwardly from the base so that after the gluing step, the cover flange extends over the tank flange to define a shoe-box like cover for the tank.

13. The method of claim 10, further comprising the step of providing a primary and secondary winding on a laminated core in the interior space.

14. The method of claim 10, further comprising the step of providing oil in the interior space.

15. The method of claim 10, further comprising mounting the tank so that the base rests on a pad.
